(19) United States
(12) Patent Application Publication
(10) Pub. No.: US 2006/0289356 A1
(43) Pub. Date: Dec. 28, 2006

(54) Digesters

(76) Inventors: Clyde H. Burnett, Little Rock, AR (US); Vern L. Tolbert, Monroe, LA (US)

Correspondence Address: FULBRIGHT & JAWORSKI L.L.P., 600 CONGRESS AVE., SUITE 2400, AUSTIN, TX, 78701, US

(21) Appl. No.: 11/433,755

(22) Filed: May 13, 2006

Related U.S. Application Data
(60) Provisional application No. 60/680,987, filed on May 13, 2005.

(51) Int. Cl. C02F 11/04

(52) U.S. Cl. 210/603; 210/613; 210/177; 210/188

(57) ABSTRACT

Methods and devices are disclosed for converting predominantly organic waste materials, such as sludge, into useful byproducts.

This application claims the benefit of priority to U.S. Provisional Patent Application No. 60/680,987 filed on May 13, 2005, which is hereby incorporated by reference in its entirety.

### BACKGROUND

1. Field

The present invention relates to methods and devices for converting predominantly organic waste materials, such as animal waste, into useful byproducts.

2. Description of Related Art

Various designs of digesters exist for the processing and treatment of primarily organic wastes (solids, semi-solids, and liquids) to produce non-hazardous, and sometimes beneficial, products for release to the environment. Digesters may be designed for use in low technology rural areas or for sophisticated industrial areas. Many types of organic wastes (i.e., municipal, industrial, agricultural, and domestic wastes) maybe treated by anaerobic digestion. See F. R. Hawkes et al., “Chapter 12: Anaerobic Digestion,” in Basic Biotechnology (J. Bu'Lock and B. Kristiansen, eds.) pp. 337-358, (Academic Press, Orlando, Fla., 1987).

Most digesters are based on either aerobic or anaerobic fermentation, although some combine elements of both. The objectives of all such digestion processes are to reduce the total amount of organic solids. Successful anaerobic digestion of organic wastes usually requires a mixed culture of bacteria with a complex interdependency, terminating in the production of methane by methanogenic bacteria. Hawkes et al., 1987. Waste digesters that use anaerobic processes have at least two advantages over those that use aerobic digestion: (1) anaerobic digestion produces methane, which can be used as a fuel gas either internally or sold commercially; and (2) anaerobic digestion is generally more efficient at removing solids, and thus produces less residual sludge than aerobic digestion and requires less energy. See U.S. Pat. No. 4,885,094.

The main disadvantage of anaerobic digesters is the long residence time typically required to digest organic waste. Many anaerobic digesters are “batch” or one-stage digesters, e.g., comprising a closed or domed vessel within which very large quantities of organic waste are fermented in batch. Anaerobic batch digesters can take 15 to 30 days to adequately digest the organic solids. See U.S. Pat. No. 5,637,219. Although these batch digesters can handle large quantities of waste, the prolonged time usually required for digestion has limited their use for municipal or industrial waste. See U.S. Pat. No. 4,885,094.

The microbiology of anaerobic digestion can be generally described as comprising four broad trophic groups, which digest organic materials in sequence. The first group, the hydrolytic and fermentative bacteria, contains both obligate and facultative anaerobes, and removes small amounts of oxygen that may be introduced into the digester with the waste influent. By hydrolysis, this group initially breaks down the more complex molecules (e.g., cellulosics, starch, proteins, lipids, etc.) into smaller units (e.g., amino acids, sugars, and fatty acids). Then, by a process of acidification, this group uses these smaller compounds to produce formate, acetate, propionate, butyrate, hydrogen, and carbon dioxide. These acidic products are then available for the next trophic level. In many digesters, the rate-limiting step is the hydrolysis of complex molecules, particularly the polysaccharides. See F. R. Hawkes et al., 1987.

The second trophic group comprises hydrogen-producing acetogenic bacteria, or proton-reducing bacteria. By a process of acetification (also called “acidification”), this group makes acetate from compounds such as fatty acids, butyrate, formate, and propionate.

The third trophic group of bacteria, comprising homoacetogenic bacteria, produces acetate from hydrogen gas and carbon dioxide. The significance of this group in digester operation is uncertain.

The final trophic group comprises the methanogenic bacteria, which convert compounds such as acetate into methane gas and carbon dioxide in a process called methanogenesis. This group is strictly anaerobic, requiring an oxygen-free environment.

Two important limitations of digesters are the rate at which waste can be processed, and the fraction of solids in the waste that can be digested. The loading rate or flow rate determines the residence time in the digester. The residence time required by standard-rate anaerobic digesters whose contents are unmixed and unheated for the microorganisms to produce a clean effluent is quite long, on the order of 30 to 60 days. Optimum anaerobic performance is achieved by proper mixing and heating. Mixing has been achieved by gas injection, mechanical stirring, and mechanical pumping. High-rate digesters whose contents are both heated and mixed have an effective residence time of about 4 days to 15 days, depending on the temperature. The shortest residence time of 4 days was for a temperature of 40° C. See Metcalf & Eddy, Inc., Wastewater Engineering, 3rd Edition, revised by G. Tchobanoglous and F. L. Burton (1991), especially Chapter 8: “Biological Unit Processes,” pp. 359-444; and Chapter 12: “Design of Facilities for the Treatment and Disposal of Sludge,” pp. 765-926.

Wastes are often characterized by the fraction of solids in the waste. One arbitrary classification scheme is low, medium, and high strength wastes, and solid wastes. These four categories can be divided on the basis of dry matter or total solids (“TS”) content as corresponding roughly to 0.2-1%, 1-5%, 5-12%, and 20-40% solids by weight, respectively. TS is also expressed as mg/L, where 20,000 mg/L equals 2% solids. TS includes both inorganic and organic solids. To measure only organic matter, either a determination of volatile solids is made by combusting all the organic material, or the organic material is chemically oxidized to give a measurement of Chemical Oxygen Demand (COD). See F. R. Hawkes et al., 1987.

Anaerobic digesters include both batch and continuous digesters. A continuous process is usually favored, since the waste is processed continuously, and there is a steady supply of methane. The classic design for industrial digesters is a variant of a one-stage digester, the continuously stirred tank reactor (“CSTR”). In a CSTR digester, all contents are completely mixed. Thus the effluent will contain some amount of freshly added, undigested waste material, and will include some active microbes. The CSTR is usually used for waste with a medium solids content, from 2 to 10% dry matter. Two alternative designs to overcome these problems are the “plug-flow” digester and the microbe retention digester. In a plug-flow digester, the waste passes through the digester in a sequential manner from the inlet to the outlet. The name “plug-flow” is usually used for designs that are unstirred and tubular. The solid material tends to move through the digester sequentially, while the liquid fraction mixes more rapidly. The retention digester is designed to retain the microorganisms in the digester. The most successful design is based on the upflow anaerobic sludge blanket (UASB), in which the waste enters the base of the digester and flows upwards through a sludge of settled bacteria. The treated waste emerges at the top and passes into a zone where any bacteria in the effluent can settle out back into the digester. However, the UASB is only useful with wastes containing low amounts of solids, typically less than 1%. See F. R. Hawkes et al., 1987.

Some anaerobic digesters are considered two-stage digesters, because the processes of hydrolysis and acidification are separated from the processes of acetification and methanogenesis. This separation usually produces methane gas with lower levels of impurities. See U.S. Pat. No. 5,637,219. Complex, multi-stage digesters have been described that spread out the digestive processes into three or more sections. See U.S. Pat. Nos. 4,604,206 and 5,637,219.

In most digesters, the temperature is controlled. The bacteria determine the optimum temperature for the digester to operate efficiently. Two common temperature ranges of digesters are a mesophilic temperature range (20° C. to 45° C.) or a thermophilic temperature range (50° C. to 65° C.). Methane production decreases if the optimal temperature range of the methanogenic bacteria is exceeded. See F. R. Hawkes et al., 1987. For example, a maximum volume of methane is produced by mesophilic anaerobic bacteria at a temperature of about 35° C., and by thermophilic bacteria at a temperature of about 55 C. Many digesters also control pH. Methanogenesis is pH dependent, with the optimal pH range from about 6 to about 8.

U.S. Pat. No. 6,254,775 describes an anaerobic digester system based on an upright vessel with internal matrices for bacteria immobilization.

U.S. Pat. No. 5,863,434 describes a process for psychrophilic (low temperature) anaerobic digestion of organic waste comprising the steps of intermittently feeding waste to a single chamber reactor containing sludge previously adapted to organic waste, and allowing the waste to react with the sludge. The waste and sludge eventually settle to form a liquid supernatant zone, which is removed as effluent, and a sludge zone.

U.S. Pat. No. 5,637,219 describes a complex, multi-stage anaerobic digester that is based on an internal rotor assembly that provides for solids mixing and for heat and mass transfer. The digester is divided by the rotor assembly into at least three or more chambers. Initially, the digester is seeded using a mixed population of anaerobic bacteria.

U.S. Pat. No. 4,885,094 describes a temperature-controlled anaerobic digester for low strength organic wastes using anaerobic microorganisms. Anaerobic digestion was accelerated by initially adding a mixture of anaerobic microorganisms, by adjusting the carbon to nitrogen ratio using waste sugar or sugar-containing product, by adjusting the nitrogen to phosphorus ratio if necessary, by controlling the pH between about 6.5 to about 8.0, and by controlling the temperature between about 30° C. to about 50° C. For wastes with 2 to 5% solids, the wastes were pretreated by adding an alkaline solution, heating, or pre-digesting. The main compartments were constructed with alternatively disposed baffles that produced a winding path flow through the compartment.

U.S. Pat. No. 4,604,206 describes a complex anaerobic digester with four different treatment sections to separate the acid-forming and gas-forming phases of anaerobic digestion and the mesophyllic and thermophilic bacteria. In each section is a rotating biological contactor and series of partitions to create zones in which the waste concentration is high and reaction rates are maximized. The digester has multiple internal heaters to control the temperature. The microorganisms in each section are pre-established on fixed media matrices that helps prevent microbial movement from one compartment to the next.

U.S. Pat. No. 4,246,099 describes an aerobic/anaerobic digestion process in which, prior to anaerobic digestion, the sludge is heated and oxygenated to partially decrease the biodegradable volatile suspended solids.

U.S. Pat. No. 6,673,243, which is incorporated herein by reference, describes a simple, inexpensive anaerobic digester that can efficiently treat organic waste of medium solids content at a shorter residence time than can conventional anaerobic digesters. The anaerobic digester is described as a multi-chambered digester that can handle wastewater sludge in large volumes at high flow rates, using a plug-flow system. The digester also allows collection of methane for use as an energy source. The digester comprises a sequential series of reaction chambers in a design that does not mechanically stir and mix the waste as it passes through the digester. The reaction chambers may optionally be contained within a single vessel, in a manner that promotes serpentine flow, or they may comprise separate vessels linked one to another. The volume of the reaction chambers may be selected to control the relative residence times of the waste to select an anaerobic microorganism group or groups that can efficiently digest the waste presented to each reaction chamber. The flow of waste is controlled to ensure that the waste passes through each reaction chamber before exiting. Under most conditions, no deliberate addition of particular bacteria is necessary. The digester works efficiently using the microbes native to the waste material. After the reaction chambers, and just prior to the exit port for the effluent, a settling chamber is located to remove any microbes and additional solids from the effluent. In one embodiment, the digester comprises four sequential reaction chambers. However, other numbers of reaction chambers and geometries will achieve similar results if the residence time in each reaction chamber is properly adjusted. For a higher yield of methane, pH could be controlled from about 6 to about 8.

U.S. Pat. No. 6,835,560, which is incorporated herein by reference, describes a process and system for contacting organic waste materials with ozone thereby converting the waste material to a substrate or medium. The substrate is a product of the process and it may be further contacted with organisms for bioconversion to further products. The organisms can include bacteria, yeast, fungi, plant cells, animal cells and genetically engineered organisms which are selected for their ability to bioconvert the substrate and produce a selected product.

Optionally, the substrate or medium can be separated from any undissolved solids after ozonation. The substrate or medium is contacted with selected organisms which are capable of using the medium to produce a product. In one embodiment, the oxidized medium can be converted into a hydrocarbon gas, such as methane. For example, a genus of methane-producing bacteria is Methanobacterium. In this embodiment, the converted medium can be fed to the methane-producing organism or, alternatively, the medium can first be partially converted into ethanol and then fed to the methane-producing organism. Once produced, the methane can be collected by typical gas collection methods and used as desired.

The process of the described invention can be used to produce other useful products through bioconversion in addition to hydrocarbon gases. For example the products produced by bioconversion of the substrate can be altered by varying the organisms used in the system. The organisms contacted with the slurry can be carefully collected in order to optimize process conditions. The organisms can be, for instance, bacteria, yeast, fungi, algae, genetically engineered microorganisms, or tissue culture. The prokaryotic and eukaryotic organisms or mixtures thereof can be cultured in the partially digested substrate. The product may be intracellular or extracellular in nature. The product may be particulate, liquid or gaseous. The product may be miscible or immiscible in water. Other products that can be formed according to the described invention include other alcohols, aldehydes, ketones, organic acids, purines, pyrymidines, alkanes, alkenes, alkynes, ethers, esters, amines, proteins, amides, cyclic aromatic compounds, enzymes, pigments, lipids, phospholipids, peroxides, gums, pharmaceuticals such as vitamins, microbial cellulose and other polymers.

In pharmaceutical manufacturing, two major product classes are produced. These are synthetic chemicals and biopharmaceuticals. Biopharmaceutical manufacturing processes include fermentation, ultrafiltration, exclusion chromatography, ion chromatography, and dialysis. Fermentation is the process by which living organisms are cultured or grown to produce a specific product. The products can be as simple as baker's yeast or alcohols, or as complex as therapeutic proteins, antibiotics, enzymes, and genetically engineered materials. The fermentation process is the most critical step in biopharmaceutical manufacturing, as this process determines the complexity of the separations chain and product yield. Biopharmaceutical fermentations tend to be very complex systems, with many potentially important control parameters. These include shear, dissolved gas levels, pH, and fermentation by-products. See Phil Dell'Orco, “Process Modeling and Control Challenges in the Pharmaceutical Industry,” http://pharmamanufacturing.com (2006).

Pharmaceutical processes generally are batch-oriented and intensely manual, including the biopharmaceutical fermenter, or bioreactor. See J. Kossik, “Think Small: Pharmaceutical Facility Could Boost Capacity and Slash Costs by Trading in Certain Batch Operations for Continuous Versions,” http://pharmamanufacturing.com (2002). A need exists in the industry for a continuous bioreactor. Benefits of a continuous biopharmaceutical bioreactor include better process control, enhanced margins of safety, increased productivity, and improved quality and yields. See Matthew J. Mollan Jr., Ph.D. and Mayur Lodaya, Ph.D., “Continuous Processing in Pharmaceutical Manufacturing,” http://pharmamanufacturing.com (2004).

### SUMMARY

Embodiments of the present invention include a digester for the digestion of organic waste or organic feedstock, the digester comprising a plurality n of at least three reaction chambers, wherein the organic waste or organic feedstock passes through each reaction chamber before exiting the digester, and wherein:

(a) each of the reaction chambers comprises an inlet and an outlet;

(b) each of the reaction chambers is adapted to foster the anaerobic microbial digestion of organic waste or organic feedstock within the reaction chamber;

(c) the first reaction chamber is adapted to receive an influent stream of organic waste or organic feedstock through the inlet of the first reaction chamber, and to transfer at least partially digested organic waste or organic feedstock through the outlet of the first reaction chamber to the inlet of the second reaction chamber;

(d) the j-th reaction chamber is adapted to receive, through the inlet of the j-th reaction chamber, at least partially digested organic waste or organic feedstock from the outlet of the (j−1)-st reaction chamber; and is adapted to transfer at least partially digested organic waste or organic feedstock from the outlet of the j-th reaction chamber to the inlet of the (j+1)-st reaction chamber, wherein j is an integer such that 1<j<n; and

(e) the n-th reaction chamber is adapted to receive, through the inlet of the n-th reaction chamber, at least partially digested organic waste or organic feedstock from the outlet of the (n−1)-st reaction chamber; and is adapted to transfer at least partially digested organic waste or organic feedstock through the outlet of the n-th reaction chamber;

wherein the digester further comprises one or more of the following elements:

(i) a collection tank, positioned upstream of one or more of the reaction chambers, in which organic waste materials or organic feedstocks are collected prior to their introduction into the first reaction chamber;

(ii) a pH sensor positioned in communication with the contents of one or more of the reaction chambers or an inflow stream thereinto;

(iii) a chemical feed tank positioned in fluid communication with one or more of the reaction chambers that introduces one or more desired chemicals thereinto;

(iv) a microbe feed tank positioned in communication with one or more of the reaction chambers that introduces selected microbes thereinto;

(v) a cleaning apparatus positioned in fluid connection with one or more of the reaction chambers;

(vi) a device for removing inorganic solids, positioned upstream of the first reaction chamber;

(vii) one or more temperature control devices that control the temperature of the organic waste or organic feedstock, wherein the control device is positioned in fluid communication with one or more of the reaction chambers;

(viii) a gas capture chamber positioned in gaseous communication with one or more of the reaction chambers;

(ix) a nutrient tank in fluid communication with one or more of the reaction chambers;

(x) a recycle chamber positioned in fluid communication with one or more of the reaction chambers;

(xi) an insulation material positioned to insulate the contents of one or more of the reaction chambers;

(xii) a waste concentration device positioned in communication with the contents of one or more of the reaction chambers or an inflow stream thereinto;

(xiii) a waste diluting device positioned in communication with the contents of one or more of the reaction chambers or an inflow stream thereinto;

(xiv) one or more microbe product chambers positioned in communication with one or more of the reaction chambers that contains selected microbes that further digest partially digested waste or organic feedstock to eventually form desired new products;

(xv) one or more anaerobic microbe recycle chambers positioned in communication with one or more of the reaction chambers that contain selected microbes that further digest partially digested waste or organic feedstock for purpose of speeding start up or maintenance of one or more said digesters; and

(xvi) one or more partitioning devices such as at least one partition, valve, or baffle used to partition the gas collected from one or more of the former chambers from the gas collected from one or more latter chambers.

In one embodiment of the present invention, the digester is controlled by a computer. In another embodiment, the computer controls the function of one or more of elements (i) through (xvi). In yet another embodiment, the collection tank includes a mixer that mixes organic materials.

In one embodiment of the present invention, the pH sensor is positioned in fluid communication with the outflow of one or more of the reaction chambers. In another embodiment, the pH sensor is positioned in fluid communication with the outflow of the n-th reaction chamber. In yet another embodiment, the pH sensor is positioned upstream of the first reaction chamber. In still another embodiment, the chemical feed tank introduces pH adjusting chemicals thereinto.

In one embodiment of the present invention, the microbe feed tank comprises one or more selected microbes. In another embodiment, at least one of the selected microbes is a genetically engineered microbe.

In one embodiment of the present invention, the cleaning apparatus comprises a pressurized water delivery system. In another embodiment, the water delivery system comprises a spray nozzle. In still another embodiment, the cleaning apparatus is positioned in fluid connection with a settling chamber.

In one embodiment of the present invention, a cyclone or series of cyclones and a pump are provided for removing inorganic solids. In another embodiment, a rotating drum screen is provided for removing inorganic solids, and in one embodiment the rotating drum screen has a screen opening of 500 microns or greater in width. In another embodiment, the temperature control device is positioned upstream of one or more of the reaction chambers. In yet another embodiment, the gas capture chamber is positioned to receive methane therein. In still another embodiment, the digester further comprises a routing channel that routes gas to another selected chamber or to a co-generation skid. In still another embodiment, the co-generation skid includes one or more of a moisture separator, an iron sponge filter, an activated carbon filter, a compressor, a methane-fueled engine, a catalytic exhaust oxidizer, an electric generator, and a switchgear to allow operation of the generator in parallel with an electric utility power grid.

In one embodiment of the present invention, the insulation material is placed on the outside of one or more of the reaction chambers. In another embodiment, the insulation material comprises about two to four inches of foam insulation covered by aluminum cladding. In another embodiment, the digester is positioned within a container to provide insulation. In yet another embodiment, the volume of the first reaction chamber is between about one-fourth and about one-half of the sum of the volumes of the second and third reaction chambers.

In one embodiment of the present invention, the digester further comprises a settling chamber adapted to receive at least partially digested organic waste or organic intermediate products from the outlet of the nth reaction chamber, where the settling chamber comprises an inlet and an outlet, the inlet is near the bottom of the settling chamber, the outlet is near the top of the settling chamber, and where the settling chamber comprises a series of baffles that establish a winding path for the flow of digesting waste or feedstock from the inlet to the outlet of the settling chamber to separate liquids, solids, and gases. In another embodiment, the digester lacks temperature control. In yet another embodiment, the digester contains no introduced microorganisms, other than those microorganisms that are present in the input organic waste without amendment by an operator of the digester.

In one embodiment of the present invention, the reaction chambers are made of stainless steel. In another embodiment, the reaction chambers are made of a calcium carbonate-containing cementitious material, whereby the acidity of waste within the digester is controlled by partial neutralization of acid by the calcium carbonate. In yet another embodiment, the digester additionally comprises a collector to collect any methane and/or other gases evolved during the anaerobic, microbial digestion of organic waste or organic feedstock.

In one embodiment of the present invention, the digester comprises at least four reaction chambers. In another embodiment, the reaction chambers comprise compartments within a single vessel, connected one to another to promote the serpentine flow of waste or feedstock through the vessel. In yet another embodiment, the reaction chambers comprise separate vessels linked together, with each separate vessel being mixed or unmixed.

Embodiments of the present invention also include a method for the anaerobic digestion of organic waste or organic feedstock; the method comprising introducing the organic waste or organic feedstock into the inlet of a first reaction chamber of the digester of certain embodiments of the present invention, and applying sufficient pressure to the organic waste or organic feedstock input to the first reaction chamber that the waste or feedstock traverses the digester, from the inlet of the first reaction chamber to the outlet of the nth reaction chamber, at a residence time such that the effluent from the nth reaction chamber has a reduction in total suspended solids as compared to the input organic waste or organic feedstock.

In one embodiment of the present invention, the residence time is about three days or less. In another embodiment, the temperature of the digester is not controlled. In yet another embodiment, the method additionally comprises the step of adding bacteria to the organic waste or organic feedstock or to the digester. In still another embodiment, the method additionally comprises the addition of a sugar to the waste or feedstock in the first reaction chamber, or prior to the first reaction chamber. In yet another embodiment, the method additionally comprises the addition of ozone to the organic waste or organic feedstock prior to its introduction into the digester.

In one embodiment of the present invention, the pH is maintained with the range from about 6 to about 8. In another embodiment, the residence time is about 48 hours or less. In another embodiment, the residence time is about 30 hours or less. In yet another embodiment, the residence time is about 24 hours or less. In still another embodiment, the residence time is about 12 hours or less. In another embodiment, the method additionally comprises the step of collecting any methane and/or other gases evolved during the anaerobic, microbial digestion of organic waste or organic feedstock.

Embodiments of the present invention also include a method of producing methane gas or hydrogen from organic waste or organic feedstock, comprising:

(a) introducing the organic waste or organic feedstock into the inlet of the first reaction chamber of a digester as recited in claim 1;

(b) applying sufficient pressure to the organic waste or organic feedstock input to the first reaction chamber that the waste or feedstock traverses the digester, from the inlet of the first reaction chamber to the outlet of the nth reaction chamber, at a residence time such that the effluent from the nth reaction chamber has a reduction in total suspended solids as compared to the input organic waste or organic feedstock; and

(c) collecting any methane or hydrogen evolved during the anaerobic, microbial digestion of the organic waste or organic feedstock.

In certain embodiments, the organic waste originates from municipal sources. In other embodiments, the organic waste originates from industrial sources. In still other embodiments, the organic waste originates from agricultural sources. It yet another embodiment, the organic waste originates from domestic sources.

Embodiments of the present invention also include a method of producing pharmaceutical products from organic feedstock, comprising: introducing organic chemicals into the inlet of the first reaction chamber of a digester as recited in claim 1; and applying sufficient pressure to the organic feedstock input to the first reaction chamber that the feedstock traverses the digester, from the inlet of the first reaction chamber to the outlet of the nth reaction chamber, at a residence time such that the effluent from the nth reaction chamber is chemically transformed into a useful and desired end product as compared to the input organic feedstock. Other chemicals and additives may be introduced into the intermediate chambers as required by the manufacturing process. Useful intermediate products may also be removed from the intermediate chambers, depending on the manufacturing process objectives.

Additional embodiments of the present invention, and details associated with those embodiments, are described below.

### BRIEF DESCRIPTION OF THE DRAWINGS

The following drawings illustrate by way of example and not limitation. Identical reference numerals do not necessarily indicate an identical structure. Rather, the same reference numeral may be used to indicate a similar feature or a feature with similar functionality. Every feature of each embodiment is not always labeled in every figure in which that embodiment appears, in order to keep the embodiments clear.

FIG. 1 is a flow diagram of one embodiment of a process and apparatus for anaerobically digesting organic wastes to reduce solids and produce methane, a useful product.

FIG. 2 is a schematic illustration of one embodiment of a process and apparatus for anaerobically digesting organic wastes and wastewater treatment sludges.

FIG. 3 is a schematic illustration of another embodiment of a process and apparatus for anaerobically digesting organic wastes and wastewater treatment sludges.

### DESCRIPTION OF ILLUSTRATIVE EMBODIMENTS

The terms “comprise” (and any form of comprise, such as “comprises” and “comprising”), “have” (and any form of have, such as “has” and “having”), “contain” (and any form of contain, such as “contains” and “containing”),and “include” (and any form of include, such as “includes” and “including”) are open-ended linking verbs. As a result, a method or apparatus that “comprises,” “has,” “contains,” or “includes” one or more elements possesses those one or more elements, but is not limited to possessing only those one or more elements or steps. Likewise, a method or apparatus that “comprises,” “has,” “contains,” or “includes” one or more features possesses those one or more features, but is not limited to possessing only those one or more features. Furthermore, a structure that is configured in a certain way must be configured in at least that way, but also may be configured in a way or ways that are not specified.

The terms “a” and “an” are defined as one or more than one unless this disclosure explicitly requires otherwise. The terms “substantially” and “about” are defined as at least close to (and includes) a given value or state (preferably within 10% of, more preferably within 1% of, and most preferably within 0.1% of). The term “another” is defined as at least a second or more.

Descriptions of well known processing techniques, components and equipment are omitted so as not to unnecessarily obscure the present methods and devices in unnecessary detail. The descriptions of the present methods and devices are exemplary and non-limiting. Certain substitutions, modifications, additions and/or rearrangements falling within the scope of the claims, but not explicitly listed in this disclosure, may become apparent to those of ordinary skill in the art based on this disclosure.

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of invention. For instance, features illustrated or described as part of one embodiment, can be used on another embodiment to yield another still further embodiment. Because it is intended that the present invention covers such modifications and variations and their equivalents.

The invention, in general, is a device and a method that reduce predominantly organic waste materials, such as wastewater treatment plant sludge or animal wastes, into useful byproducts. Following the waste being collected, optionally concentrated or diluted, optionally temperature controlled, optionally pH adjusted, optionally nutritionally supplemented, optionally chemically supplemented, and optionally microbially supplemented prior to entering one or more of the reaction chambers in the digester, the conversion of the waste requires contacting the selected waste material with selected microorganisms in one or more reaction chambers of the digester to yield digested waste products. The digester may also be used to produce methane and/or hydrogen gas. The digester may also be used to manufacture pharmaceutical products from certain organic chemical feedstocks.

According to some embodiments of the present invention, various waste materials are first collected. The organic waste materials are particularized, if necessary, optionally diluted or concentrated to create the slurry, and subsequently optionally temperature controlled, and subsequently optionally adjusted for optimum pH, and subsequently optionally nutritionally supplemented, and subsequently optionally microbes added, and fed into the digester into one or more reaction chambers.

In a first embodiment of a four reaction chambered anaerobic digester in accordance with the present invention, the multichambered digester provides a series of environments that select for anaerobic microorganisms that efficiently digest wastewater sludge. Under most operating conditions, no microorganisms will have to be added above those naturally found in the sludge. However if organic waste is from an industrial source, such as a poultry processing plant, a mixed population of aerobic or anaerobic microorganisms may need to be added initially.

The organic waste is supplemented with nutrients, examples of which are sugar and trace elements, from a nutrient tank, which is in fluid connection with the waste influent that is in fluid connection with one or more reaction chambers of the digester. In a second embodiment of a multichambered anaerobic digester, the multichambered digester provides a series of environments that select anaerobic microorganisms that efficiently digest wastewater sludges. The organic waste flows into a collecting tank. A fraction of the volume contained in the collecting tank is continuously pumped through a controllable temperature control device that controls the temperature of the organic waste, one example of which is a heat exchanger. The organic waste, now at a controllable temperature, is supplemented with nutrients, one example of which is sugar, from a nutrient tank, which is in fluid connection with the waste influent that is in fluid connection with one or more reaction chambers of the digester. The organic waste, now at a controllable temperature, is measured for pH with the pH sensor positioned in fluid communication. The organic waste, now at a controllable temperature, is supplemented with chemicals from a chemical feed tank positioned in fluid communication. The chemicals may change the pH of the waste stream.

In a third embodiment of a multichambered anaerobic digester, the multichambered digester provides a series of environments that select for anaerobic microorganisms that efficiently digest wastewater sludges. The organic waste influent is collected in a holding tank. The solid concentration may be adjusted in this chamber. The organic waste after solid concentration adjustment is in fluid connection with a collection tank. A fraction of the volume contained in the collection tank is continuously pumped through a device or devices for removing inorganic solids, such as a rotating drum screen or a centrifugal separator or cyclone, which are positioned upstream of the first reaction chamber. A fraction of the volume contained in the collection tank is continuously pumped through a controllable temperature control device that controls the temperature of the organic waste, one example of which is a heat exchanger. The organic waste, now at a controllable temperature, is supplemented with nutrients, or catalysts, one example of which is sugar, from a nutrient tank, which is in fluid connection with the waste influent that is in fluid connection with one or more reaction chambers of the digester. The organic waste, now at a controllable temperature, is measured for pH with the pH sensor positioned in fluid communication. The organic waste, now at a controllable temperature, is supplemented with chemicals from a chemical feed tank positioned in fluid communication. The chemicals may change the pH of the waste stream.

Under most operating conditions, no microorganisms will have to be added above those naturally found in the sludge. However if organic waste is from an industrial source, such as a poultry processing plant, a mixed population of aerobic or anaerobic microorganisms may need to be added initially.

In the first, second, and third embodiments of the multichambered anaerobic digester described above, the initial reaction chamber can receive the sugar solution to boost the available carbon source, if the waste has a low carbon concentration, for example, if the sludge has been predigested aerobically. For previously untreated sludge, the sugar addition may prove unnecessary. In some embodiments, the digester does not contain a rotor, another moving mechanical mixer, or gas aerator to mix the contents.

The predominant microorganisms selected in the first reaction chamber are hydrolytic and fermentative bacteria. In the subsequent reaction chambers, increasing percentages of acetogenic and methanogenic bacteria are selected. The volume of the first reaction chamber relative to the sum of the volume of the next two reaction chambers is important, and should be about one half to one fourth the sum of the volumes of reaction chambers two and three. Since volume of the reaction chamber determines the relative residence time for any given flow rate, the first chamber will have a lower residence time than that of reaction chambers two and three. Without wishing to be bound by this theory, it is believed that digestion by the hydrolytic and fermentative bacteria of reaction chamber one is a faster process than either acetogenesis and methanogenesis, the primary processes in reaction chambers two and three. The relative sizes of reaction chambers two and three to reaction chamber four are less important. Methane gas rises to the top of one or more reaction chambers and can be collected as produced. The production of methane can be estimated by methods known in the art. See Metcalf & Eddy, Inc., Chapter 8 (1991).

By using naturally occurring microorganisms, and by compartmentalizing the selection of organisms that most effectively thrive on the material found in that particular compartment, the digester efficiently and rapidly digests the waste. This efficiency is surprising because no bacteria normally need be added to the sludge, and the contents of the reactor need not be mechanically stirred.

There are several advantages to this simple, plug flow anaerobic digester. First, the overall size of the digester can be adjusted to handle a wide range of waste volumes. Second, the multichamber anaerobic digester enables digestion to proceed at a high rate, reducing the residence time necessary to produce a clean effluent. Third, the digester requires neither predigestion nor spiking with bacteria to initiate anaerobic digestion; only an additional carbon source may be needed, depending on the nature of the waste stream. The amount of carbon addition is based on the carbon content of the waste material. Preferred sources of carbon include waste sugars or sugar containing products, such as glucose or sucrose from a source such as blackstrap molasses, raw sugar, or accrued product from beat or cane processing. Moreover, if the waste source has a low microbe concentration, such as some industrial waste, the addition of some microorganisms may be helpful. Finally, this digester is energy-efficient since no internal moving parts are required in many embodiments.

Once the digester is operating and producing a clean effluent, the flow rate can be increased to handle a larger volume of waste material. Without wishing to be bound by this theory, it is believed that a residence time as short as 12 hours can eventually be achieved that produces a clean effluent while maximizing solids reduction. To establish the microorganism population in the reaction chambers of the digester, organic waste is initially fed to the digester at a flow rate to achieve a residence time of approximately 72 to 96 hours. Steady-state is achieved after about five residence times. Once steady-state is attained, the flow rate can be increased to achieve an operational residence time of 48 hours, and eventually to a residence time as short as approximately 12 hours.

Steady-state is determined by comparing the concentration of organic matter of the influent material with that of the effluent. The amount of organic material may be measured by the chemical oxygen demand, that is, COD. Another parameter of interest is the total suspended solids (“TSS”), which is the total fraction of solids, both organic and inorganic, by weight. Steady-state may be defined as an average removal of over about 70% of both organic material and suspended solids from the influent.

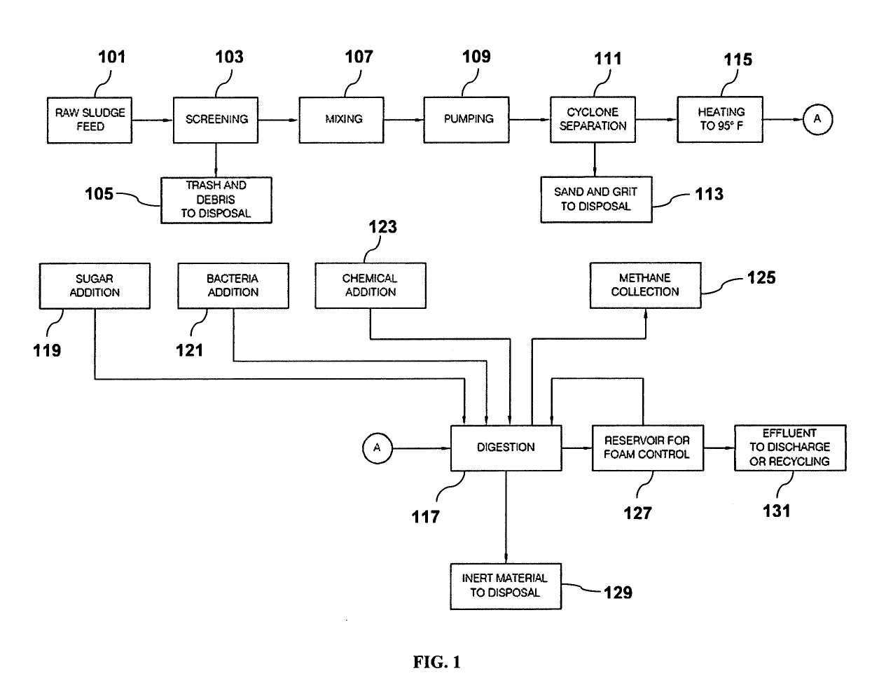

A general flow diagram of one embodiment of the process and apparatus of the present invention for anaerobically digesting organic wastes is illustrated in FIG. 1. Raw organic waste or sludge 101 in liquid form with a solids concentration generally less than 5% dry solids by weight may first be screened in a screening stage 103 to remove any trash and debris that may be contained within the waste sludge, although this separation step is optional, with the trash and debris being disposed of in a disposal stage 105. The screened sludge is accumulated in a tank and mixed in a mixing stage 107 to keep solids in suspension. The mixed sludge is pumped in a pumping stage 109 through a centrifugal separator, or cyclone, in a separation stage 111 to remove entrained sand and grit, although this separation stage is optional, with the sand and grit disposed of in a disposal stage 113. The sludge is then heated to approximately 95° F. in a heating stage 115 and then enters the reaction chambers of the plug flow digester, consisting of a single baffled tank subdivided into chambers, or, for larger sludge flows, separate individual tanks connected together in series, for a digestion stage 117. In this embodiment, sugar 119, bacteria 121, and other chemicals 123 are added to the digester to maintain the proper carbon:nitrogen ratio or to serve as a catalyst, maintain pH, provide a bacteria seed, or for other reasons. Methane is produced by the digester which can be collected in a collection stage 125 for beneficial use or flared. Effluent from the digester, being largely free of solids and deoxygenated, is routed to a reservoir 127 to be used for foam suppressant within the tank(s). Some inert material that accumulates in the digester over time is periodically removed by the operator in a disposal stage 129. Finally, effluent from the reservoir is then routed to discharge or recycling in a final routing stage 131.

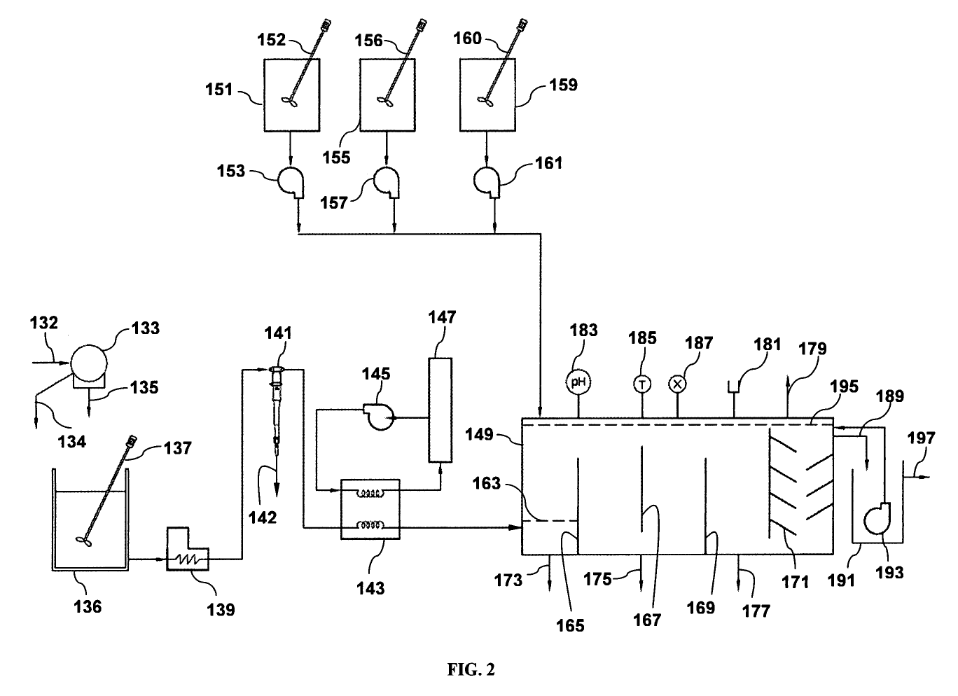

One embodiment of the process and apparatus of the present invention for anaerobically digesting organic wastes and wastewater treatment sludges is schematically illustrated in FIG. 2. Organic waste or sludge 132 is fed into a rotating drum screen 133. Trash and debris 134 is removed from the sludge by the drum screen. Screened sludge 135 is discharged into a holding tank 136 where solids are kept in suspension by a mixer 137. A positive displacement pump 139 forces the sludge through a centrifugal separator 141, or cyclone, with adequate force to remove entrained sand and grit 142 contained within the sludge. The screened and degritted sludge then passes through a heat exchanger 143 wherein the sludge is heated to a temperature of approximately 95° F. A water circulation pump 145 is used to circulate hot water from a water heater 147 through the heat exchanger to provide a heat source for raising the sludge temperature. The screened, degritted, and heated sludge then enters the reaction chambers of the digester 149. Also entering the reaction chambers of the digester, as required by the particular waste, are a sugar solution to maintain the desired carbon:nitrogen ratio, or to serve as a catalyst, from the sugar solution tank 151 (with mixer 152) and feed pump 153, a buffering chemical to maintain the desired pH from the buffering chemical tank 155 (with mixer 156) and feed pump 157, and bacteria seed to accelerate digester acclimation by the bacteria seed tank 159 (with mixer 160) and feed pump 161. The digester contains a ported baffle plate 163 to equalize flow across the digester, and a series of vertical baffle plates 165, 167, and 169 arranged to provide the optimum geometry for high-rate plug flow anaerobic digestion. Slanted plates 171 are provided in the final chamber to promote sedimentation, gas separation, and retainage of residual solids contained within the sludge stream after digestion.

Inert material that may accumulate in the digester over time is removed from the bottom of the digester chambers through drains 173, 175, and 177. Digester gas comprising methane, carbon dioxide, and small amounts of other gases produced in the digestion process is discharged through an exhaust stack 179 on top of the digester where it may be collected for beneficial use. Gas safety equipment consisting of a flame arrestor and a combination pressure and vacuum relief valve 181 is located on top of the digester. Instruments are installed on the digester to measure pH 183, temperature 185, and solids concentration 187. Effluent from the digester is discharged through the outlet pipe 189 into an effluent holding tank 191. A pump 193 is used to periodically transport digester effluent through a spraying system 195 on the interior of the digester to reduce foam accumulation. Digester effluent 197, being largely free of solids, is generally recycled to the wastewater collection or treatment system used to produce the original sludge, or to another wastewater treatment system. In this way most of the sludge solids are continually reduced to digester gas through the process, with the only solids disposal required consisting of trash, debris, sand, grit, and inert material that must be removed periodically from the site by the operator.

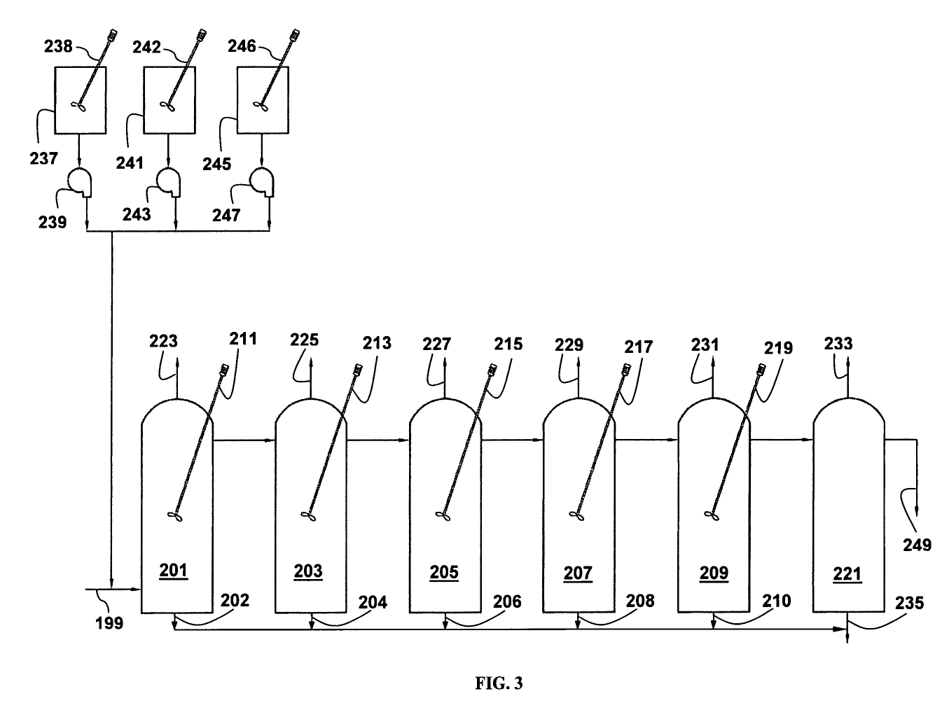

Another embodiment of the process and apparatus of the present invention for anaerobically digesting organic wastes and wastewater treatment sludges is schematically illustrated in FIG. 3. Instead of the single digester tank 149 shown in FIG. 2, a series of separate individual enclosed tanks are arranged in a plug flow pattern as illustrated in FIG. 3. Screened, degritted, and heated sludge 199 is pumped into digester tank 201. Older, partially digested sludge in tank 201 is transferred to tank 203 by gravity or by pumping. Similarly, older, partially digested sludge is transferred to subsequent digester tanks 205, 207, and 209. The number of tanks used may vary as required to digest the particular waste stream, with a total of six tanks shown in the illustration. All of the tanks may have mixing equipment 211, 213, 215, 217, and 219 to keep the solids in suspension, except the last tank 221, although the mixing equipment 211, 213, 215, 217, and 219 are optional. All of the tanks are equipped with gas collection pipes 223, 225, 227, 229, 231, and 233, where the digester gas may be collected for beneficial use. The last tank 221 in the series does not contain a mixer.

The organic waste or sludge in this tank will contain primarily fixed or inert solids that are undigestable. These solids are allowed to separate from the liquid flow and accumulate in the tank. The accumulated inert solids 202, 204, 206, 208, 210, and 235 are removed periodically from the site by the operator.

Also entering the series of digester tanks, as required by the particular waste, are a sugar solution to maintain the desired carbon:nitrogen ratio or to serve as a catalyst from the sugar solution tank 237 (with mixer 238) and feed pump 239, a buffering chemical to maintain the desired pH from the buffering chemical tank 241 (with mixer 242) and feed pump 243, and bacteria seed to accelerate digester acclimation by the bacteria seed tank 245 (with mixer 246) and feed pump 247. These supplements may be added to the influent pipe of the first tank in series or separately and independently to any tank in the series as may be required by the particular waste to achieve optimum anaerobic digestion. Digester effluent 249, being largely free of solids, is generally recycled to the wastewater collection or treatment system used to produce the original sludge, or to another wastewater treatment system. In this way most of the sludge solids are continually reduced to digester gas through the process, with the only solids disposal required consisting of trash, debris, sand, grit, and inert material that must be removed periodically from the site by the operator.

In lieu of waste sludge, the digester system embodied in FIG. 2 may also be used to digest other organic feedstocks in order to manufacture pharmaceutical products.

It should be understood that the present apparatuses and methods are not intended to be limited to the particular forms disclosed. Rather, they are to cover all modifications, equivalents, and alternatives falling within the scope of the claims. In addition, it should be understood that aspects of the various embodiments may be interchanged both in whole or in part.

The claims are not to be interpreted as including means-plus- or step-plus-function limitations, unless such a limitation is explicitly recited in a given claim using the phrase(s) “means for” or “step for,” respectively.

We claim:

1. A digester for the digestion of organic waste or organic feedstock, the digester comprising a plurality n of at least three reaction chambers, wherein the organic waste or organic feedstock passes through each reaction chamber before exiting the digester, and wherein:
(a) each of the reaction chambers comprises an inlet and an outlet;
(b) each of the reaction chambers is adapted to foster the anaerobic microbial digestion of organic waste or organic feedstock within the reaction chamber;
(c) the first reaction chamber is adapted to receive an influent stream of organic waste or organic feedstock through the inlet of the first reaction chamber, and to transfer at least partially digested organic waste or organic feedstock through the outlet of the first reaction chamber to the inlet of the second reaction chamber;
(d) the j-th reaction chamber is adapted to receive, through the inlet of the j-th reaction chamber, at least partially digested organic waste or organic feedstock from the outlet of the (j−1)-st reaction chamber; and is adapted to transfer at least partially digested organic waste or organic feedstock from the outlet of the j-th reaction chamber to the inlet of the (j+1)-st reaction chamber, wherein j is an integer such that 1<j<n; and
(e) the n-th reaction chamber is adapted to receive, through the inlet of the n-th reaction chamber, at least partially digested organic waste or organic feedstock from the outlet of the (n−1)-st reaction chamber; and is adapted to transfer at least partially digested organic waste or organic feedstock through the outlet of the n-th reaction chamber;
wherein the digester further comprises one or more of the following elements:
(i) a collection tank, positioned upstream of one or more of the reaction chambers, in which organic waste materials or organic feedstocks are collected prior to their introduction into the first reaction chamber;
(ii) a pH sensor positioned in communication with the contents of one or more of the reaction chambers or an inflow stream thereinto;
(iii) a chemical feed tank positioned in fluid communication with one or more of the reaction chambers that introduces one or more desired chemicals thereinto;
(iv) a microbe feed tank positioned in communication with one or more of the reaction chambers that introduces selected microbes thereinto;
(v) a cleaning apparatus positioned in fluid connection with one or more of the reaction chambers;
(vi) a device for removing inorganic solids, positioned upstream of the first reaction chamber;
(vii) one or more temperature control devices that control the temperature of the organic waste or organic feedstock, wherein the control device is positioned in fluid communication with one or more of the reaction chambers;
(viii) a gas capture chamber positioned in gaseous communication with one or more of the reaction chambers;
(ix) a nutrient tank in fluid communication with one or more of the reaction chambers;
(x) a recycle chamber positioned in fluid communication with one or more of the reaction chambers;
(xi) an insulation material positioned to insulate the contents of one or more of the reaction chambers;
(xii) a waste concentration device positioned in communication with the contents of one or more of the reaction chambers or an inflow stream thereinto;
(xiii) a waste diluting device positioned in communication with the contents of one or more of the reaction chambers or an inflow stream thereinto;
(xiv) one or more microbe product chambers positioned in communication with one or more of the reaction chambers that contains selected microbes that further digest partially digested waste or organic feedstock to eventually form desired new products;
(xv) one or more anaerobic microbe recycle chambers positioned in communication with one or more of the reaction chambers that contain selected microbes that further digest partially digested waste or organic feedstock for purpose of speeding start up or maintenance of one or more said digesters; and
(xvi) one or more partitioning devices such as at least one partition, valve, or baffle used to partition the gas collected from one or more of the former chambers from the gas collected from one or more latter chambers.

2. The digester of claim 1, wherein the digester is controlled by a computer.

3. The digester of claim 2, wherein the computer controls the function of one or more of elements (i) through (xvi).

4. The digester of claim 1, wherein the collection tank includes a mixer that mixes organic materials.

5. The digester of claim 1, wherein the pH sensor is positioned in fluid communication with the outflow of one or more of the reaction chambers.

6. The digester of claim 1, wherein the pH sensor is positioned in fluid communication with the outflow of the n-th reaction chamber.

7. The digester of claim 1, wherein the pH sensor is positioned upstream of the first reaction chamber.

8. The digester of claim 1, wherein the chemical feed tank introduces pH adjusting chemicals thereinto.

9. The digester of claim 1, wherein the microbe feed tank comprises one or more selected microbes.

10. The digester of claim 9, wherein at least one of the selected microbes is a genetically engineered microbe.

11. The digester of claim 1, wherein the cleaning apparatus comprises a pressurized water delivery system.

12. The digester of claim 1, wherein the water delivery system comprises a spray nozzle.

13. The digester of claim 1, wherein the cleaning apparatus is positioned in fluid connection with a settling chamber.

14. The digester of claim 1, wherein the device for removing inorganic solids comprises a cyclone or series of cyclones and a pump.

15. The digester of claim 1, wherein the device for removing inorganic solids comprises a rotating drum screen.

16. The digester of claim 15, wherein the rotating drum screen has a screen opening of about 500 microns or greater in width.

17. The digester of claim 1, wherein the temperature control device is positioned upstream of one or more of the reaction chambers.

18. The digester of claim 1, wherein the gas capture chamber is positioned to receive methane therein.

19. The digester of claim 1, further comprising a routing channel that routes gas to another selected chamber or to a co-generation skid.

20. The digester of claim 19, wherein the co-generation skid includes one or more of a moisture separator, an iron sponge filter, an activated carbon filter, a compressor, a methane-fueled engine, a catalytic exhaust oxidizer, an electric generator, and switchgear to allow operation of the generator in parallel with an electric utility power grid.

21. The digester of claim 1, wherein the insulation material is placed on the outside of one or more of the reaction chambers.

22. The digester of claim 1, wherein the insulation material comprises about two to four inches of foam insulation covered by aluminum cladding.

23. The digester of claim 1, wherein the digester is positioned within a container to provide insulation.

24. The digester of claim 1, where the volume of the first reaction chamber is between about one-fourth and about one-half of the sum of the volumes of the second and third reaction chambers.

25. The digester of claim 1, further comprising a settling chamber adapted to receive at least partially digested organic waste or organic intermediate products from the outlet of the nth reaction chamber, where the settling chamber comprises an inlet and an outlet, the inlet is near the bottom of the settling chamber, the outlet is near the top of the settling chamber, and where the settling chamber comprises a series of baffles that establish a winding path for the flow of digesting waste or feedstock from the inlet to the outlet of the settling chamber to separate liquids, solids, and gases.

26. The digester of claim 1, wherein the digester lacks temperature control.

27. The digester of claim 1, wherein the digester contains no introduced microorganisms, other than those microorganisms that are present in the input organic waste without amendment by an operator of the digester.

28. The digester of claim 1, wherein the reaction chambers are made of stainless steel.

29. The digester of claim 1, wherein the reaction chambers are made of a calcium carbonate-containing cementitious material, whereby the acidity of waste within the digester is controlled by partial neutralization of acid by the calcium carbonate.

30. The digester of claim 1, additionally comprising a collector to collect any methane and/or other gases evolved during the anaerobic, microbial digestion of organic waste or organic feedstock.

31. The digester of claim 1, wherein the digester comprises at least four reaction chambers.

32. The digester of claim 1, wherein the reaction chambers comprise compartments within a single vessel, connected one to another to promote the serpentine flow of waste or feedstock through the vessel.

33. The digester of claim 1, wherein the reaction chambers comprise separate vessels linked together, with each separate vessel being mixed or unmixed.

34. A method for the anaerobic digestion of organic waste or organic feedstock; the method comprising introducing the organic waste or organic feedstock into the inlet of a first reaction chamber of a digester as recited in claim 1, and applying sufficient pressure to the organic waste or organic feedstock input to the first reaction chamber that the waste or feedstock traverses the digester, from the inlet of the first reaction chamber to the outlet of the nth reaction chamber, at a residence time such that the effluent from the nth reaction chamber has a reduction in total suspended solids as compared to the input organic waste or organic feedstock.

35. The method of claim 34, wherein the residence time is about three days or less.

36. A method as in claim 34, wherein the temperature of the digester is not controlled.

37. A method as in claim 34, additionally comprising the step of adding bacteria to the organic waste or organic feedstock to the digester.

38. A method as in claim 34, additionally comprising the addition of a sugar to the waste or feedstock in the first reaction chamber, or prior to the first reaction chamber.

39. A method as in claim 34, additionally comprising the addition of ozone to the organic waste or organic feedstock prior to its introduction into the digester.

40. A method as in claim 34, wherein the pH is maintained with the range from about 6 to about 8.

41. A method as recited in claim 34, wherein the residence time is about 48 hours or less.

42. A method as recited in claim 34, wherein the residence time is about 30 hours or less.

43. A method as recited in claim 34, wherein the residence time is about 24 hours or less.

44. A method as recited in claim 34, wherein the residence time is about 12 hours or less.

45. A method as recited in claim 34, additionally comprising the step of collecting any methane and/or other gases evolved during the anaerobic, microbial digestion of organic waste or organic feedstock.

46. A method of producing methane gas or hydrogen gas from organic waste or organic feedstock, comprising:
(a) introducing the organic waste or organic feedstock into the inlet of the first reaction chamber of a digester as recited in claim 1;
(b) applying sufficient pressure to the organic waste or organic feedstock input to the first reaction chamber that the waste or feedstock traverses the digester, from the inlet of the first reaction chamber to the outlet of the nth reaction chamber, at a residence time such that the effluent from the nth reaction chamber has a reduction in total suspended solids as compared to the input organic waste or organic feedstock; and
(c) collecting any methane or hydrogen gas evolved during the anaerobic, microbial digestion of the organic waste or organic feedstock.

47. A method as in claim 46, wherein the organic waste originates from municipal sources.

48. A method as in claim 46, wherein the organic waste originates from industrial sources.

49. A method as in claim 46, wherein the organic waste originates from agricultural sources.

50. A method as in claim 46, wherein the organic waste originates from domestic sources.
